(19) United States
(12) Patent Application Publication
(10) Pub. No.: US 2017/0161294 A1
(43) Pub. Date: Jun. 8, 2017

(54) FILE DIRECTORY STORAGE ON A STORAGE DEVICE

(71) Applicant: HEWLETT PACKARD ENTERPRISE DEVELOPMENT LP, Houston, TX (US)

(72) Inventors: Anand Ganjihal, Bangalore (IN); Anoop Kumar Raveendran, Bangalore (IN); Santigopal Mondal, Bangalore (IN); Sandya Srivilliputtur Mannarswamy, Bangalore (IN)

(21) Appl. No.: 15/327,421

(22) PCT Filed: Sep. 18, 2014
(86) PCT No.: PCT/US2014/056337

§ 371 Date: Jan. 19, 2017

(30) Foreign Application Priority Data
Jul. 30, 2014 (IN) 3722/CHE/2014

(51) Int. Cl. G06F 17/30

(52) U.S. Cl. CPC G06F 17/30138; G06F 17/30144; G06F 17/30091; G06F 17/30135

(57) ABSTRACT

Some examples described herein relate to storing file directories on a storage device. In an example, a portion of available free space on a storage device may be assigned for storing file directories only. Upon receipt of a request for allocating storage space to a file directory on the storage device, the assigned portion may be utilized to store the file directory.

### BACKGROUND

A file system is a means for organizing data on a storage device. In other words, a file system may be used to control how data is stored and retrieved from a storage system. Typically, data may be stored as a “file”. A file system provides the basic structure for organizing files in a storage device. For instance, a file may be placed in a directory or subdirectory of a file system. The file system keeps track of file locations (physical or virtual) on a storage medium.

### BRIEF DESCRIPTION OF THE DRAWINGS

For a better understanding of the solution, embodiments will now be described, purely by way of example, with reference to the accompanying drawings, in which:

FIG. 1 is a block diagram of an example computing device for storing file directories;

FIG. 2 is a block diagram of an example storage device indicating a reserved portion for storing file directories;

FIG. 3 is a block diagram of an example storage device for storing file directories;

FIG. 4 is a flowchart of an example method for storing file directories on a storage device; and

FIG. 5 is a block diagram of an example system for storing file directories.

### DETAILED DESCRIPTION

A file system is an integral part of an operating system. It provides the underlying structure that a computing device uses to organize data on a storage medium. A computer file or “file” is the basic component of a file system. Each piece of data on a storage device may be called a “file”. A file may contain data, such as text files, image files, video files, and the like, or it may be an executable file or program.

Files may be organized by storing related files in a directory or sub-directory. A directory or sub-directory is also a file. The term “directory” (or “file directory), as used herein, may include a file that contains references (for example, names) to other files. Thus, a directory may be considered as a container for files. Each directory might consist of several files and in order to store these file names and respective inode number (i.e. (filename, inode number)), it may require several on-disk pages. Each such page is called as directory page. Directory page, thus, is a container which may hold a finite set of filenames and respective inode mapping i.e. {filename, inode number}. Apart from {filename, inode number}, a directory page may hold other metadata relevant to an inode or a file.

In a hierarchical file system, a directory contained inside another directory is called a subdirectory. The top-most directory in such a file system, which does not have a parent of its own, is called the root directory.

Increased adoption of technology by businesses has led to an explosion of data, which is typically organized by a file system as a collection of files and directories. A file system may be associated with a volume, which is, generally, a single accessible storage area on a single partition of a storage medium, such as a hard disk, optical disc, NAND flash memory, etc. A volume may be divided into blocks, which is a sequence of bits or bytes. Many file systems use blocks to store file and directories. In an instance, a file or directory may be stored over several blocks that may be located at various places on a volume. In other words, a directory may be spread over different physical areas of a storage medium. One of the reasons for fragmentation of directory extents is that a directory page allocation request is serviced from same free space pool on a storage medium which is used for servicing other storage allocation requests such as a data or tag page allocation request.

If the directories and their pages on a storage medium are fragmented i.e. they are not close enough; it may cause a number of issues. For instance, it may result in a longer read latency since a directory may be scattered over multiple blocks in a storage medium. It may lead to a longer disk spindle movement and, consequently, more power consumption since multiple I/O reads may be required. In another instance, it may impact the performance of a file correction tool, such as a file system check (fsck), since in order to validate a directory tree and correct name space connectivity, an fsck tool may need to walk the name space resulting in read of several directories and their respective directory pages on disk. If the directories and their pages on disk are not close enough, it may result in longer read latency and affect the performance of fsck tool.

To prevent these issues, the present disclosure describes various examples for storing file directories on a storage device. In an example, a portion of available free space on a storage device may be assigned or demarcated for storing file directories only. When a request for allocating storage space for a file directory is received, the assigned portion may be used to store the file directory. In an instance, this would lead to aggregation of the directories and directory pages, which would help bring the directories close to each other, thereby improving the read latency, directory listing and fsck tool directory tree connectivity phase.

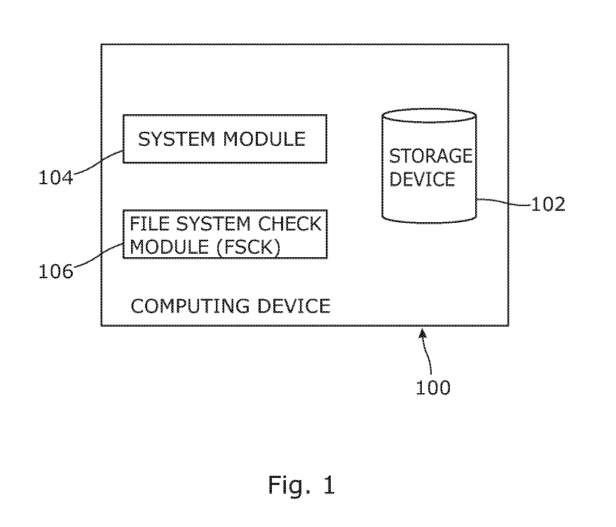

FIG. 1 is a block diagram of an example computing device 100 for storing file directories. Computing device 100 generally represents any type of computing system capable of reading machine-executable instructions. Examples of computing device may include, without limitation, a server, a desktop computer, a notebook computer, a tablet computer, a thin client, a mobile device, a personal digital assistant (PDA), a phablet, and the like. In an example, computing device 100 may be a file storage system.

In the example of FIG. 1, computing device 100 may include a data storage device or medium 102, a system module 104, and a file system check (fsck) module 106. Storage device 102 may be a primary storage device such as, but not limited to, random access memory (RAM), read only memory (ROM), processor cache, or another type of dynamic storage device that may store information and machine-readable instructions that may be executed by a processor. For example, Synchronous DRAM (SDRAM), Double Data Rate (DDR), Rambus DRAM (RDRAM), Rambus RAM, etc. Storage device 102 may be a secondary storage device such as, but not limited to, a floppy disk, a hard disk, a CD-ROM, a DVD, a pen drive, a flash memory (e.g. USB flash drives or keys), a paper tape, an Iomega Zip drive, and the like. Storage device 102 may be a tertiary storage device such as, but not limited to, a tape library, an optical jukebox, and the like. In another example, storage device 102 may be a Direct Attached Storage (DAS) device, a Network Attached Storage (NAS) device, a tape drive, a magnetic tape drive, a data archival storage system, or a combination of these devices.

In an example, storage device 102 may store data based on a block-based file system. In a block based file system, files are typically stored in units known as blocks, which is a sequence of bytes or bits. Many file systems use blocks to store file and directories. In such case, data is read as a whole block. A block includes data only from a single file. In many instances, a storage device (example, 102) may contain empty blocks. These may include unused blocks i.e. blocks on which no data have been written so far or blocks from which data has been deleted. Such areas (or blocks) on a storage device (example, 102) may be termed as “free space.”

Some non-limiting examples of file systems that may be used on storage device (example, 102) may include FAT (FAT12, FAT16, FAT32), NTFS, HFS and HFS+, HPFS, UFS, ext2, ext3, and ext4. Further, various allocation methods may be used to allocate a file on storage device (example, 102). An allocation method refers to how disk blocks are allocated for files. For example, in contiguous allocation, each file may occupy a set of contiguous blocks on the storage device (example, 102). In another form of contiguous allocation, a file system may allocate disk blocks in extents. An extent is a contiguous block of disks, which may be used for file allocation. A file may consist of one or more extents. In linked allocation, each file may be a linked list of disk blocks, and the blocks may be scattered anywhere on the disk. In indexed allocation, all pointers to file data are brought together in an index block.

In an example, a section of available free storage space on a storage device (example, 102) may be assigned or reserved for storing file directories or directory pages only. In others words, free space available on a storage medium (example, 102) may be analyzed, and a portion of such free space may be reserved for storing file directories or directory pages only. The reserved area of free storage space may not be used for storing any other file, such as a data file, a metadata file, an executable file, etc., apart from a file directory or directory page.

When a request is received for allocating storage space to a directory (or directory page) on the storage device 102, system module 104 may allocate storage space to the directory (or directory page), from the assigned section only. In other words, all directory or directory page allocation requests may get storage space from the reserved section of the storage device (example, 102) only. This results in aggregation of directories and directory pages in a specific physical area of the storage device (example, 102). Likewise, if a request is received for allocating storage space to a sub-directory of a file directory already stored in the assigned section of the storage device (example, 102), the sub-directory may be allocated a storage space in physical proximity of the file directory in the assigned portion of the storage space. In another instance, upon receipt of a request for allocating storage space to a sub-directory of a file directory already stored in the assigned section of the storage device, system module 104 may allocate to the sub-directory a storage space contiguous to the storage space allocated to the file directory in the assigned portion of the available free space. In a contiguous allocation, both the file directory and the sub-directory may occupy a set of contiguous blocks on the disk.

In the event a request is received for allocating storage space to a file associated with a file directory (for e.g., a data file), such request may be fulfilled from the unassigned portion of the available free storage space.

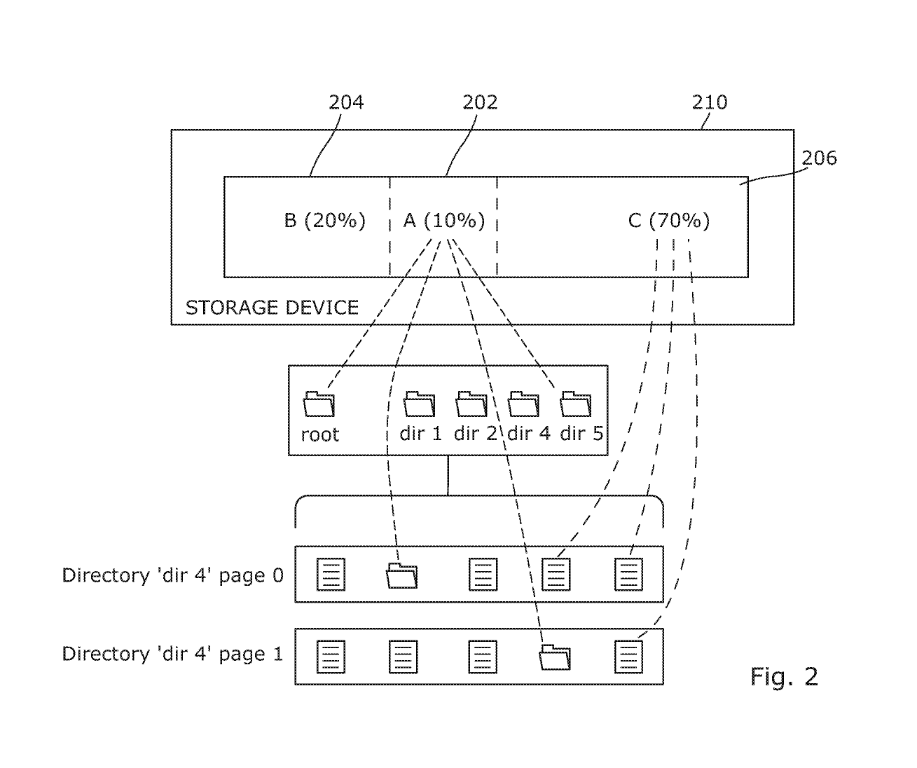

In an example, the portion of available free space assigned only for storing a file directory (or a directory page) is proportionate (for example, percentage) to the available free space on the storage device (example, 102). This is illustrated in FIG. 2. A portion (10%; indicated as “A”) 202 of free storage space 200 on a storage device 210, in the example of FIG. 2, may be reserved for storing file directories (or directory pages) such as root directory (or “root”), dir 1, dir 2, dir 4, and dir 5. A portion (20%; indicated as “B”) 204 of the remaining free storage space may be used for allocating storage to metadata files. The remaining free space (70%; indicated as “C”) 206 may be used for allocating storage to, for instance, data files of a directory stored in portion “A”. For instance, page 0 and page 1 of directory “dir 4”.

In an instance, computing device 100 may include a file system check (fsck) module 106. An fsck module 106 may be used for checking and repairing file system inconsistencies on the storage device. A file system may become inconsistent, for example, due to power failure, a nonstandard shutdown, hardware failure, etc. This may cause inconsistencies and mismatched information relating to data blocks, free blocks, inodes, etc. in a file system. In an example, allocating a portion of available free space on a storage device for storing file directories only, and utilizing the assigned portion to store a file directory, may enable an fsck module 106 to improve read latency during directory tree validation involving the file directories. It may also enable a file system check (fsck) module 106 to check consistency of a file system that includes such directories (or directory pages).

The term “module” may refer to a software component (machine readable instructions), a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. A module may reside on a volatile or non-volatile storage medium (for example, 102) and configured to interact with a processor of a computing device (e.g. 100).

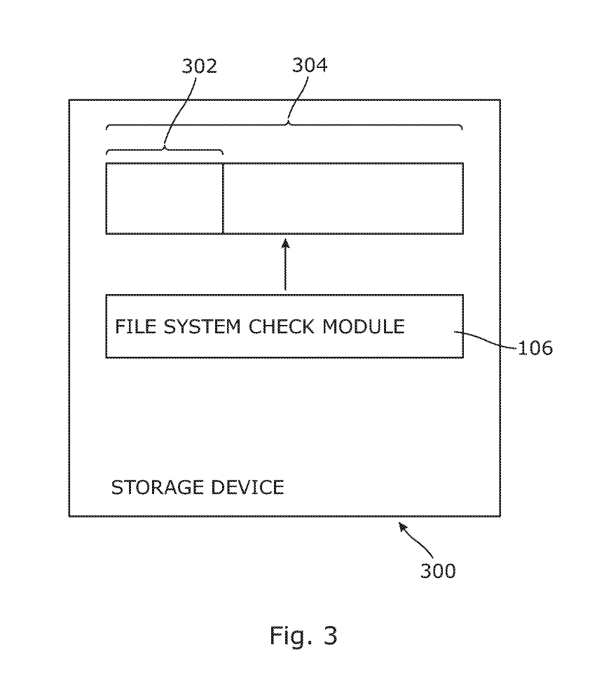

FIG. 3 is a block diagram of an example storage device 300 for storing file directories. In an example, the storage device may be analogous to storage device 102, in which like reference numerals correspond to the same or similar, though perhaps not identical, components. For the sake of brevity, components or reference numerals of FIG. 3 having a same or similarly described function in FIG. 1 are not being described in connection with FIG. 3. Said components or reference numerals may be considered alike.

Storage device 300 may be a primary storage device such as, but not limited to, random access memory (RAM), read only memory (ROM), processor cache, or another type of dynamic storage device that may store information and machine-readable instructions that may be executed by a processor. For example, Synchronous DRAM (SDRAM), Double Data Rate (DDR), Rambus DRAM (RDRAM), Rambus RAM, etc. Storage device 102 may be a secondary storage device such as, but not limited to, a floppy disk, a hard disk, a CD-ROM, a DVD, a pen drive, a flash memory (e.g. USB flash drives or keys), a paper tape, an Iomega Zip drive, and the like. Storage device 300 may be a tertiary storage device such as, but not limited to, a tape library, an optical jukebox, and the like. In another example, storage device 300 may be a Direct Attached Storage (DAS) device, a Network Attached Storage (NAS) device, a tape drive, a magnetic tape drive, a data archival storage system, or a combination of these devices.

In an example, storage device may include a section 302 dedicated for storing only file directories (or directory pages) of a file system. The section 302 is a portion of available free space on the storage device wherein all file directories (or directory pages) of the file system may be stored. Storing all file directories (or directory pages) in the dedicated section 302 improves the read latency during directory tree validation involving such file directories.

Storage device may include a file system check (fsck) module 106, which may be analogous to the fsck module described earlier. In an example, fsck module 106 may perform directory tree validation of a file system comprising file directories (and/or directory pages) stored in the dedicated section of the storage device.

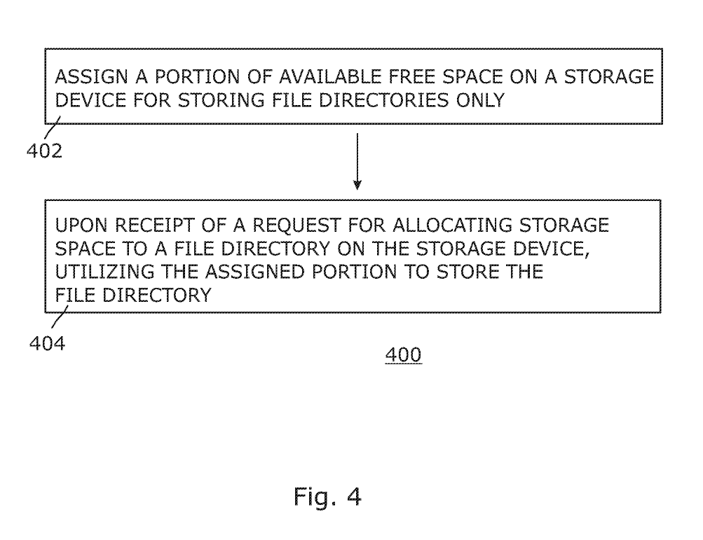

FIG. 4 is a flowchart of an example method 400 for storing file directories on a storage device. The method 400, which is described below, may at least partially be executed on a computing device 100 of FIG. 1 or storage device 300 of FIG. 3. However, other computing devices may be used as well. At block 402, a portion of available free space on a storage device (example, 102) may be assigned for storing file directories (or directory pages) only. In other words, a directory or directory page allocation request to a computing or storage device (example, 102) may get storage space (for example, a disk block) from a specific storage space reserved for such requests. Thus, instead of allocating directory pages from a common free storage space pool, which may be contended by other requests such as file data allocation requests, a directory page is allocated from a specific portion of the available free storage space.

In an example, prior to reserving a portion of available free space on a storage device for storing file directories (or directory pages); the free space available on the storage space may be determined. In another example, the portion of available free space assigned or reserved for allocating storage space to a directory (or directory page) may increase or decrease (i.e. it may grow or shrink dynamically, as required) depending on various pre-defined factors. These may include, by way of example, the available free space on a storage device at a given time or period, number of directory (or directory page) requests in a given period, etc.

At block 404, upon receipt of a request for allocating storage space to a file directory on the storage device (example, 102), the portion of the available free space assigned for storing file directories (or directory pages) may be utilized to store the file directory. In an example, if a request is received for allocating storage space to a sub-directory of a file directory already stored in the assigned section of the storage device, the sub-directory may be allocated a storage space in physical proximity of the file directory in the assigned portion of the storage space. In another instance, upon receipt of a request for allocating storage space to a sub-directory of a file directory already stored in the assigned section of the storage device (example, 102), the sub-directory may be allocated a storage space contiguous to the storage space allocated to the file directory in the assigned portion of the available free storage space. Allocating directories (or directory pages) in a reserved area of storage space, the directory pages are stored close to each other, thereby reducing directory fragmentation.

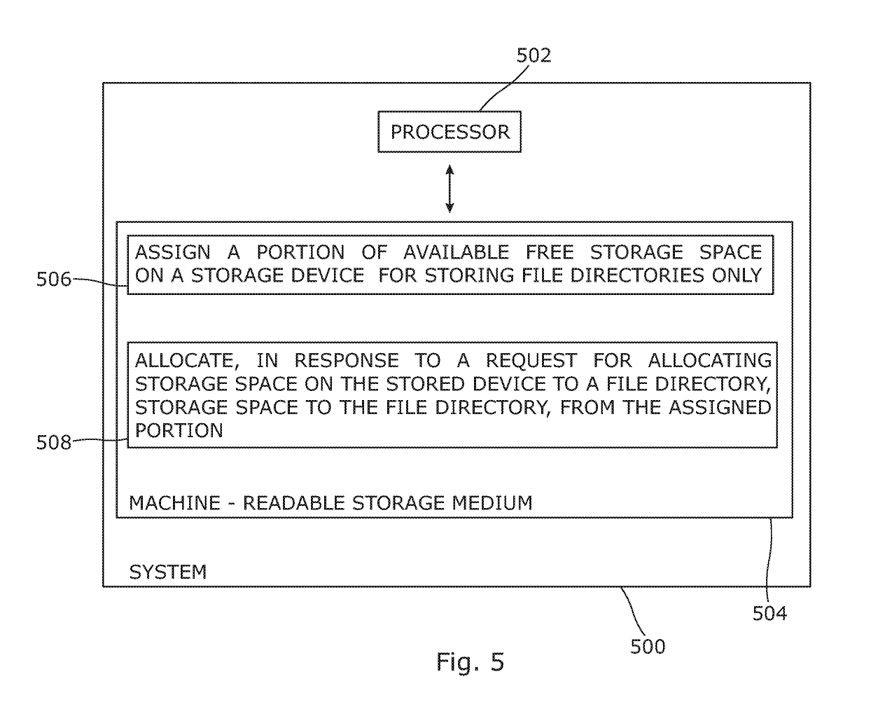

FIG. 5 is a block diagram of an example system 500 for ensuring data integrity of a retained file upon replication to a target system. System 500 includes a processor 502 and a machine-readable storage medium 504 communicatively coupled through a system bus. In an example, system 500 may be analogous to computing device 100 of FIG. 1 or storage device 300 of FIG. 3. Processor 502 may be any type of Central Processing Unit (CPU), microprocessor, or processing logic that interprets and executes machine-readable instructions stored in machine-readable storage medium 504. Machine-readable storage medium 504 may be a random access memory (RAM) or another type of dynamic storage device that may store information and machine-readable instructions that may be executed by processor 502. For example, machine-readable storage medium 504 may be Synchronous DRAM (SDRAM), Double Data Rate (DDR), Rambus DRAM (RDRAM), Rambus RAM, etc. or a storage memory media such as a floppy disk, a hard disk, a CD-ROM, a DVD, a pen drive, and the like. In an example, machine-readable storage medium 504 may be a non-transitory machine-readable medium. Machine-readable storage medium 504 may store instructions 506 and 508. In an example, instructions 506 may be executed by processor 502 to assign a portion of available free storage space on a storage device (example, 102) for storing file directories only. Instructions 508 may be executed by processor 502 to allocate, in response to a request for allocating storage space on the storage device (example, 102) to a file directory, storage space to the file directory, from the assigned portion. Storage medium 504 may further include instructions to allocate, in response to a request for allocating storage space on the storage device to a file associated with the file directory, storage space to the file, from an unassigned portion of the available free storage space.

For the purpose of simplicity of explanation, the example method of FIG. 4 is shown as executing serially, however it is to be understood and appreciated that the present and other examples are not limited by the illustrated order. The example systems of FIGS. 1, 3 and 5, and method of FIG. 4 may be implemented in the form of a computer program product including computer-executable instructions, such as program code, which may be run on any suitable computing device in conjunction with a suitable operating system (for example, Microsoft Windows, Linux, UNIX, and the like). Embodiments within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It may be noted that the above-described examples of the present solution is for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

1. A method for storing file directories on a storage device, comprising:
assigning a portion of available free space on the storage device for storing file directories only; and
for each of a plurality of file directories, upon receipt of a request for allocating storage space to the file directory on the storage device, utilizing the assigned portion to store the file directory.

2. The method of claim 1, further comprising: upon receipt of a request for allocating storage space to a sub-directory of one of the file directories on the storage device, allocating a storage space to the sub-directory in physical proximity of the one of the file directories in the assigned portion of the available free space.

3. The method of claim 1, wherein the size of the portion of available free space assigned for storing file directories varies based on a pre-defined factor.

4. The method of claim 1, wherein the size of the portion of available free space assigned only for storing the file directory is a percentage of the available free space on the storage device.

5. The method of claim 1, further comprising: upon receipt of a request for allocating storage space to a sub-directory of one of the file directories on the storage device, allocating, storage space to the sub-directory, storage space contiguous to the storage space allocated to the one of the file directories in the assigned portion of the available free space.

6. The method of claim 1, further comprising enabling a file system check (fsck) module to improve read latency during directory tree validation involving the file directories.

7. A system, comprising:
a storage device;
a processor; and
a non-transitory machine-readable storage medium comprising instructions executable by a processor to:
assign a section of available free space on the storage device to store only file directories and directory pages; and
for each of a plurality of file directories, upon receipt of a request for allocating storage space to the file directory, allocate storage space from the assigned section to the file directory.

8. The system of claim 16, wherein the instructions further comprise file system check (fsck) instructions executable to check consistency of a file system that includes the directory page.

9. The system of claim 16, wherein the instructions further comprise instructions to store the directory page in the allocated storage space.

10. The system of claim 7, wherein the size of the section of available free space assigned for storing only file directories and directory pages is proportionate to the available free space on the storage device.

11. (canceled)

12. The system of claim 7, wherein the instructions further comprise file system check (fsck) instructions to perform a directory tree validation.

13. A non-transitory machine-readable storage medium comprising instructions executable by a processor to:
assign a portion of available free storage space on a storage device for storing file directories only; and
for each of a plurality of file directories, in response to a request for allocating storage space on the storage device to the file directory, allocate storage space to the file directory from the assigned portion.

14. The storage medium of claim 13, further comprising instructions to allocate, in response to a request for allocating storage space on the storage device to a file associated with the file directory, storage space to the file, from an unassigned portion of the available free storage space.

15. The storage medium of claim 13, wherein one of the file directories is stored in an extent of the assigned portion.

16. The system of claim 7, wherein the instructions further comprise instructions executable to:
upon receipt of a request for allocating storage space to a directory page, allocate storage space from the assigned section to the directory page.
